(19) United States
(12) Patent Application Publication
(10) Pub. No.: US 2021/0272097 A1
(43) Pub. Date: Sep. 2, 2021

(54) SYSTEMS AND METHODS FOR CONTACTLESS CARD-BASED CREDENTIALS

(71) Applicant: JPMORGAN CHASE BANK, N.A., New York, NY (US)

(72) Inventors: Jin WEN, Fremont, CA (US); Jeffrey D. LANGUS, Mamaroneck, NY (US); Leonard Michael GUSEL, New York, NY (US)

(21) Appl. No.: 16/803,625

(22) Filed: Feb. 27, 2020

(51) Int. Cl. G06Q 20/32; G06Q 20/34; G06Q 20/40; G06Q 40/02; H04L 9/30; H04L 9/32

(52) U.S. Cl. CPC G06Q 20/3278; G06Q 20/352; G06Q 20/4014; G06Q 40/02; G06Q 20/4012; G06Q 2220/00; G06Q 20/3226; H04L 9/3073; H04L 9/3234; H04L 9/3226; G06Q 20/3223

(57) ABSTRACT

Exemplary embodiments provide systems and methods for contactless card-based credentials. According to one embodiment, in a backend information processing apparatus comprising at least one computer processor, a method for provisioning an authentication credential to an electronic device, may include: (1) receiving, from an electronic device associated with a user, card data for a contactless card, an authorization cryptogram, and a challenge response; (2) authenticating the user based on the authorization cryptogram, the card data, and the challenge response; (3) generating and sending a response cryptogram to the electronic device; (4) returning a cardholder account to the electronic device; (5) wherein the electronic device generates a public/private key pair for the electronic device, an online service, and the cardholder account; and (6) wherein the electronic device persists the public/private key pair in secure storage thereon.

### BACKGROUND OF THE INVENTION

### 1. Field of the Invention

Embodiments are directed to systems and methods for contactless card-based credentials.

### 2. Description of the Related Art

To log into an account that a customer may have with a financial institution, the customer often provides a username, password, and occasionally a one-time passcode (OTP) that may be received by SMS, email, or voice. These are prone to phishing, Man-in-the-middle (MITM) attacks, SMS SS7 vulnerability, Brute Force Account Credential Testing (BFACT) traffic, and others.

In the digital channel (web and mobile), the account recovery process is usually a high risk, lengthy and easily circumvented effort, which involves entering a social security number, a tax ID number, and/or some knowledge-based verification (e.g., out-of-wallet questions such as mother's maiden name), where this information is readily-available to criminals due to numerous data breaches in recent years. To control potential account take over risk, a typical account recovery process may also require second factor authentication such as OTP as mentioned above. In this case, if customers no longer have accessed to email addresses or phone numbers registered in their account profiles, they have to call customer service as the last resort. This kind of recovery process is not only vulnerable to attack, but also increase customer support volume and create unnecessary customer friction.

### SUMMARY OF THE INVENTION

Exemplary embodiments provide systems and methods for contactless card-based credentials. According to one embodiment, in a backend information processing apparatus comprising at least one computer processor, a method for provisioning an authentication credential to an electronic device, may include: (1) receiving, from an electronic device associated with a user, card data for a contactless card, an authorization cryptogram, and a challenge response; (2) authenticating the user based on the authorization cryptogram, the card data, and the challenge response; (3) generating and sending a response cryptogram to the electronic device; (4) returning a cardholder account to the electronic device; (5) wherein the electronic device generates a public/private key pair for the electronic device, an online service, and the cardholder account; and (6) wherein the electronic device persists the public/private key pair in secure storage thereon.

In one embodiment, the contactless card may be a NFC-enabled card.

In one embodiment, the challenge may include a PIN.

In one embodiment, the electronic device may communicate the public key to the online service, and the online service may store the public key.

In one embodiment, the authorization cryptogram may include an authorization request cryptogram, and the response cryptogram may include an authorization response cryptogram.

According to another embodiment, in a mobile electronic device associated with a user comprising at least one computer processor, a method for provisioning an authentication credential to a mobile electronic device may include: (1) receiving card data for a contactless card; (2) generating an authorization cryptogram for the card data; (3) prompting the user for a challenge response; (4) receiving the challenge response from the user; (5) communicating the card data, the authorization cryptogram, and the challenge response to a financial institution backend; (6) receiving, from the financial institution backend, a response cryptogram; (7) generating a public/private key pair for the electronic device, an online service, and the cardholder account; and (8) persisting the public/private key pair in secure storage.

In one embodiment, the contactless card may be a NFC-enabled card.

In one embodiment, the challenge may include a PIN.

In one embodiment, the method may further include communicating the public key to the online service, and the online service may store the public key.

According to another embodiment, in a mobile electronic device associated with a user comprising at least one computer processor, a method for processing an access request received on a mobile electronic device may include: (1) receiving card data for a contactless card; (2) receiving an authentication credential from secure storage on the mobile electronic device; (3) communicating an access request comprising the card data and the authentication credential to a backend; and (4) receiving approval for the access request from the backend. The backend may retrieve stored card data for a contactless card associated with the authentication credential and may approve the access request when the card data matches the stored card data.

In one embodiment, the card may include a NFC card.

In one embodiment, the method may further include prompting the user for a challenge response; and receiving the challenge response from the user. The backend may verify the user based on the card data and the challenge response.

In one embodiment, the challenge response may include a PIN.

In one embodiment, the access request may include access to an application executed by the mobile electronic device.

In one embodiment, the access request may include access to an application executed by a second mobile electronic device

In one embodiment, the access request may include a request to change a password or passcode for an application or a website.

In one embodiment, the access request may include a transaction request.

In one embodiment, the access request may include a login request to a website.

In one embodiment, the request may be to authenticate a user to a third party.

In one embodiment, the authentication credential may include a public/private keypair.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for contactless card-based credentials according to one embodiment;

FIG. 2 depicts a method for generating an authentication credential based on validation of contactless card-based credentials according to one embodiment;

FIG. 3 depicts a method for account password or passcode recovery using a provisioned authentication credential according to one embodiment;

FIG. 4 depicts a method for account management using a provisioned authentication credential according to one embodiment;

FIG. 5 depicts a method for transaction authorization using a provisioned authentication credential according to one embodiment; and

FIG. 6 depicts a method for establishing an authenticated session using a provisioned authentication credential according to one embodiment.

### DETAILED DESCRIPTION OF PREFERRED EMBODIMENTS

The present disclosure generally relates to systems and methods for contactless card-based credentials.

In embodiments, a contactless-enabled card (e.g., a credit card, debit card, etc.) may be presented to (e.g., tapped) a mobile electronic device (e.g., a smartphone, smart watch, tablet computer, Internet of Things (IoT) device, etc.), and information from the contactless-card may be read by an application or program executed by the mobile electronic device.

The application or program executed by the mobile electronic device, or a backend, may provision an authentication credential based on the information received. In one embodiment, the authentication credential may be provisioned specifically for use by the user using the device and application.

For subsequent logins, a username or userid, and one or more additional modality may be used. For example, a first modality may include a biometric (i.e., something the user is) and a PIN (i.e., something the user knows) may be used in the event the first modality fails (e.g., due to environmental conditions, hardware failure, or deactivation due to risk). In one embodiment, the PIN may be a n-digit knowledge-based login credential for access to the digital channel (e.g., a mobile app, website). It may be different from, for example, a PIN for a financial instrument (e.g., a debit card PIN), a device PIN or passcode, etc. Though the user may set these PIN values to be the same, these PINs may not be used interchangeably for all the same use-cases, they are not generated, stored, or validated in the same way, and they do not synchronize when one is changed.

As used herein:

“Identity proofing” is the means to verify and authenticate the identity of the legitimate customer;

“Provisioning” is the act of providing a login credential (representing the user/device/app) to be used for authentication at subsequent digital channel logins; and

“Authentication” is the act of validating the provisioned login credential after it has been provisioned.

Identity proofing and user authentication are both instances of identity corroboration, a process or action that evaluates evidence to support a claim of identity. From this context, identity proofing is the process of corroborating the identity of a person who was previously a stranger to the business. Authentication is the process of corroborating the identity of a person who is already known to the business. Putting these concepts in a real banking use case, it goes like this: Identity Proofing typically happen when a person need to open a bank account. Per Know-your-customer (KYC) regulation, the banker need to verify this person by checking SSN and photo ID such as driver license and/or passport. Once the ID is validated, bank account is created, the customer receives a Chip-and-PIN EMV card “provisioned” by the bank. When customer withdraws cash from ATM with this valid EMV card and card PIN, it is considered a Strong Customer Authentication (SCA) by the European Banking Authority (EBA). In this case, customer's identity is “corroborated” to the bank not by a photo ID, but by a bank card and a PIN. This is a common banking practice to verify a valid customer.

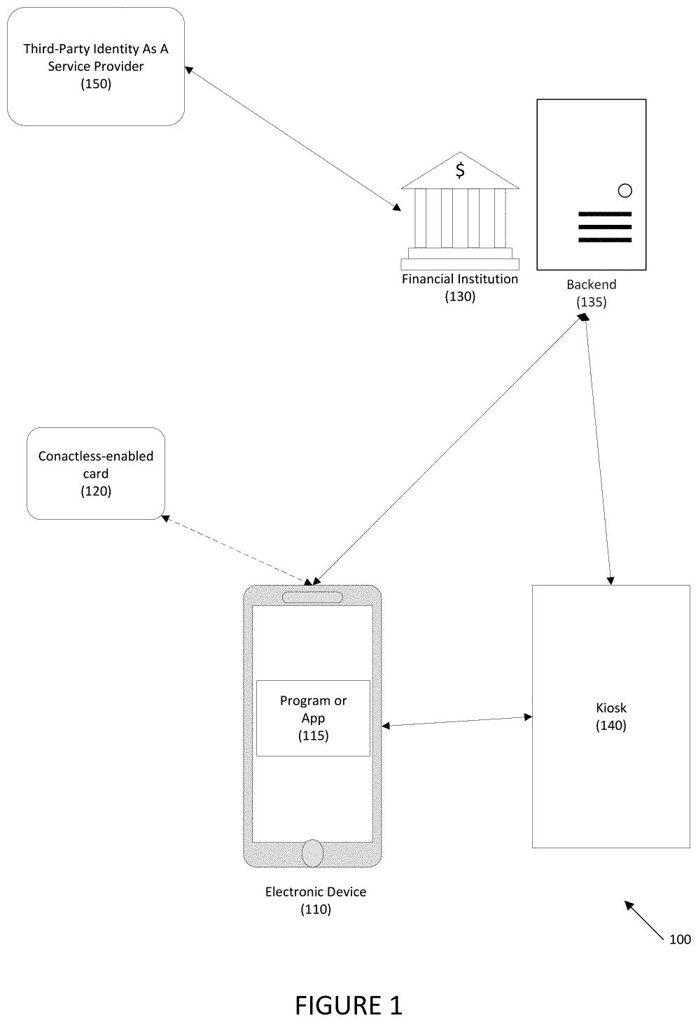

Referring to FIG. 1, an exemplary system for contactless card-based credentials is disclosed according to one embodiment. System 100 may include electronic device 110, which may execute program or app 115. Electronic device 110 may be any suitable electronic device, including smart phones, smart watches, tablet computers, notebook computers, Internet of Things (IoT) appliances, etc. In one embodiment, electronic device 110 may be any electronic device that is NFC or similarly enabled.

Contactless-enabled card 120 may be any suitable payment or other identify card that is NFC or similarly enabled. For example, contactless-enabled card 120 may be a credit card, a debit card, etc. that may be issued by a financial institution.

Backend 135 may be a backend for financial institution 130. In one embodiment, financial institution 130 may be the issuer of contactless-enabled card 130.

In one embodiment, program or app 115 may be associated with the financial institution.

Kiosk 140 may be a kiosk, ATM, teller terminal, etc. that may communicate with backend 130. In one embodiment, kiosk 140 may be used to perform identify proofing (e.g., payment credential and PIN capture) to request the backend 130 to communicate over-the-air to mobile device 110 to initiate provisioning if mobile device 110 is not NFC or similarly enabled.

System 100 may further include third-party identity as a service provider 150. In one embodiment, third-party identity as a service provider 150 may provide identity services to financial institution 130.

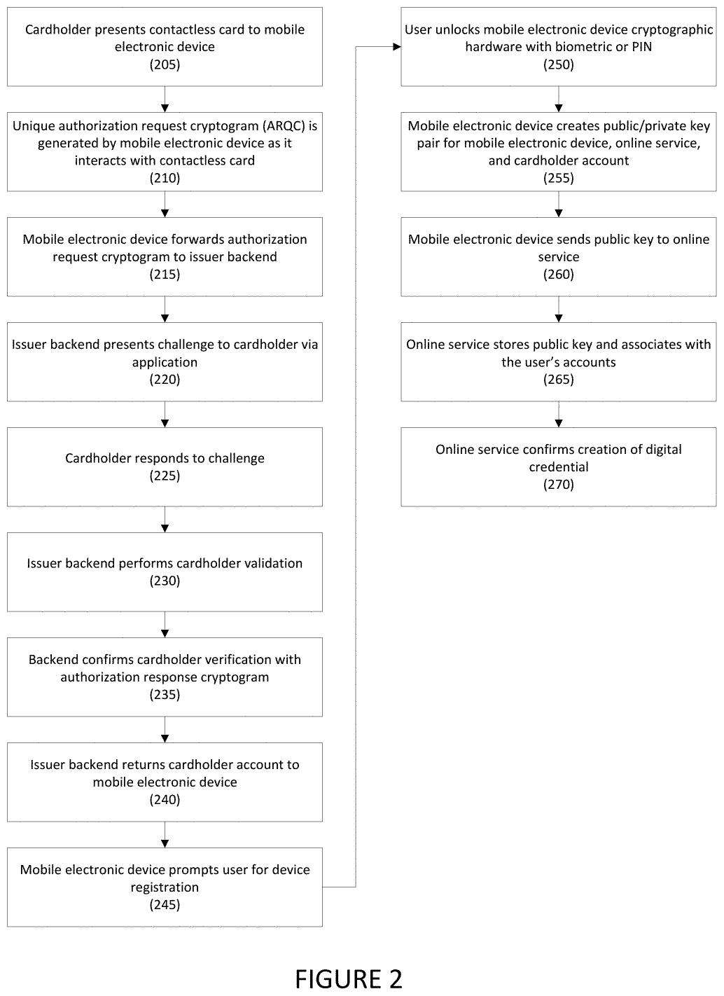

Referring to FIG. 2, a method for generating an authentication (login) credential based on validation of contactless (e.g., NFC (ISO/IEC 14443)) card-based credentials is disclosed according to one embodiment.

In step 205, a cardholder may present a contactless-enabled card (e.g., NFC) to a mobile electronic device, or may select an existing digitally-provisioned payment credential from the financial institution's digital payment wallet. In one embodiment, the card may be presented within a very short range (e.g., less than 4 cm) from the mobile electronic device.

In step 210, a unique cryptogram may be dynamically generated within the mobile NFC device when it is interacting with EMV chip inside the contactless NFC card. In one embodiment the cryptogram may be an authorization request cryptogram (ARQC).

In step 215, the cryptogram may be sent to an issuer backend. In one embodiment, this may be part of an authorization request.

In step 220, the issuer backend may present a challenge to the cardholder for verification, such as entering a personal identification number (PIN). In one embodiment, the PIN may be a PIN for a financial instrument (e.g., a debit card PIN), a zip code (e.g., a U.S. zip code that is tied to the credit card billing address) or a device Personal Identification Number (PIN) in Android or passcode in Apple iOS.

In step 225, the cardholder may respond to the challenge by entering the requested information.

In step 230, issuer backend may perform Cardholder Verification Method (CVM) per EMVCo guidelines as well as other fraud detection control measures.

In step 235, the issuer backend may provide a response including an authorization response cryptogram (ARPC).

In step 240, the issuer backend may return the cardholder account to the mobile electronic device, and in step 245, may prompt the user for device registration. In response, in step 250, the user may unlock the mobile device's cryptographic hardware using a biometric, a PIN, etc.

In step 255, the mobile electronic device may create a public/private key pair for mobile electronic device, an online service (e.g., an online service associated with the issuer), and the cardholder account. In step 260, the mobile electronic device may send the public key to the online service, and in step 265, the online service may store the public key and associate it with the user's account(s).

For example, the backend may instruct the device to securely generate and store an authentication credential, such as a cryptographic authentication credential, on the mobile electronic device's secure storage, such as the Trusted Execution Environment (TEE) for Android, SecureEnclave for iOS, in the form of a unique public/private keypair. The authentication credential may cryptographically represent a binding of the user, the device information, and the application data. A popular protocol that describe this interaction is FIDO registration, where the user's device creates a new public/private key pair unique for the local device, online service and user's account.

In step 270, the online service may confirm the creation of a digital credential.

In one embodiment, if the mobile electronic device and/or the contactless card are not NFC enabled, the cardholder may present the card to a kiosk, such as an ATM, and may authenticate at the kiosk by entering a card PIN. If the cardholder has more than one mobile electronic device, the kiosk may ask the cardholder to identify the mobile electronic device on which the authentication credential will be stored (e.g., by providing a drop-down list, a phone number, etc.). The backed in communication with the kiosk may validate the provisioning request and may communicate to the mobile device to generate the authentication credential. For example, the instruction to create the authentication credential may be pushed over the air to the mobile electronic device.

In another embodiment, the cardholder may perform a NFC tap of a previously-provisioned payment credential (e.g., a digital ATM card) using the mobile electronic device, or a physical card with a kiosk, ATM, or teller terminal.

Subsequently, the payment credential that was communicated to the kiosk/ATM/teller terminal may be used to prompt the user to perform identity proofing by entering the Debit PIN on the kiosk/ATM/teller terminal device. The back-end may then instruct the mobile electronic device to initiate the local creation of the authentication credential to be used for subsequent login.

In another embodiment, the cardholder may perform identify proofing using input from an “identity as a service provider.”

In another embodiment, the authentication credential may be used to provide identity as a service to a relying party, such as a credit bureau, to perform a credit check, to a third party digital payment wallet to perform maintenance and payment card provisioning, or to enable a digital experience with an approved third-party vendor.

In another embodiment, the authentication credential may be used for account password or passcode recovery. For example, rather than go through a recovery process to recover a locked password, the cardholder may use a biometric to recover or re-enable the n-digit PIN should it become disabled due to risk parameters. Alternatively, the cardholder may use the n-digit PIN to recover or re-enable the biometric.

In one embodiment, the authentication credential may be used as part of a browser login to a financial institution or relying party website. For example, when logging into to a website, the website may present an option to send push notification to mobile device registered with the user, prompting the user to authenticate on the mobile device using the financial institution's provisioned authentication cryptographic credential (e.g., the biometric or n-digit PIN). The successful authentication on the mobile device enables the browser to initiate an authenticated session.

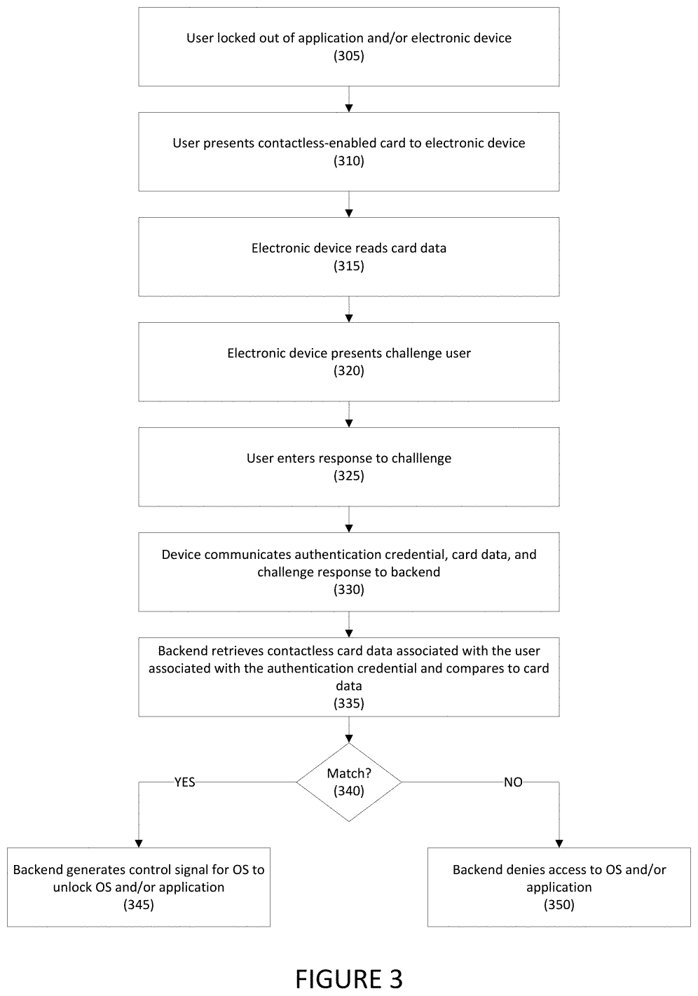

Referring to FIG. 3, a method for account password or passcode recovery using a provisioned authentication credential is disclosed according to one embodiment.

In step 305, a user may be locked out of an application on an electronic device that is provisioned with an authentication credential. For example, the user may have forgotten his or her password or passcode. In one embodiment, the user may also be locked out of the operating system.

In step 310, the user may present the contactless-enabled card to the electronic device. For example, the user may tap the contactless-enabled card on the electronic device.

In step 315, the electronic device may read data from the contactless-enabled card.

In step 320, the electronic device may present a challenge to the user for verification, such as entering a personal identification number (PIN). In one embodiment, the PIN may be a PIN for a financial instrument (e.g., a debit card PIN), a zip code (e.g., a U.S. zip code that is tied to the credit card billing address) or a device Personal Identification Number (PIN) in Android or passcode in Apple iOS.

In step 325, the user may respond to the challenge by entering the requested information.

In one embodiment, the challenge and the challenge response may be optional.

In step 330, the electronic device may communicate the authentication credential, the card data, and the challenge response (if received) to a backend, such as the entity that issued the authentication credential.

In step 335, the backend may retrieve contactless card data for cards associated with the user associated with the authentication credential, and may verify that the card data received matches that for a contactless card issued to the user. Thus, the same contactless card that was used to provision the authentication credential need not be presented.

The backend may further validate the challenge response, if provided.

In step 340, if there is a match, in step 345, the backend may issue a control signal to unlock the OS and/or the application. If there is not a match, in step 350, the OS and/or application may remain locked.

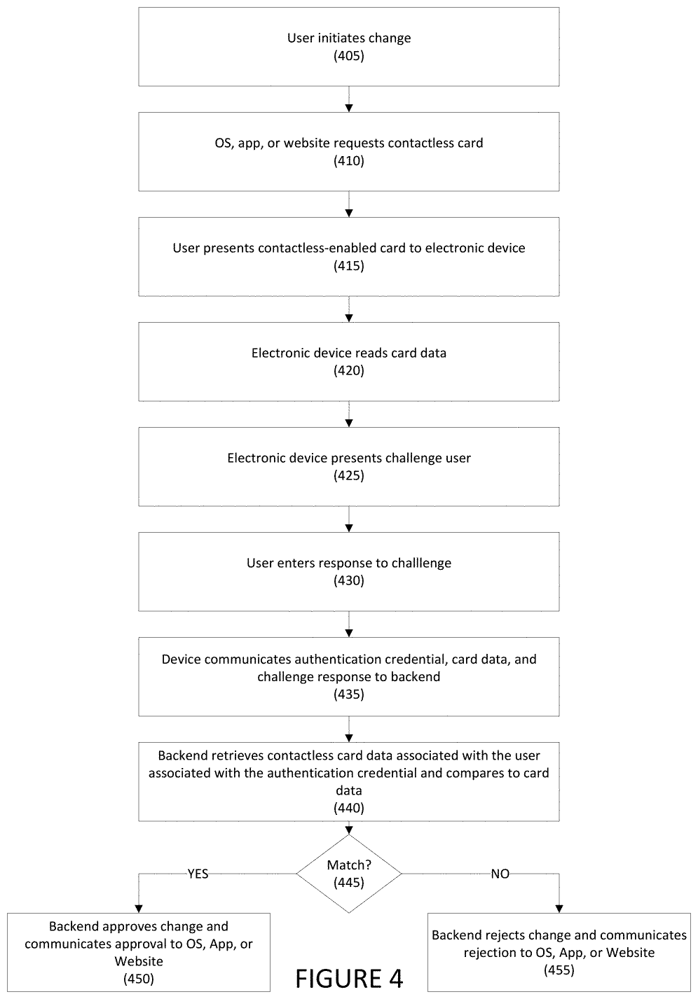

Referring to FIG. 4, a method for account management using a provisioned authentication credential is disclosed according to one embodiment.

In step 405, a user may initiate changing a passcode or password for an electronic device, a password to an app executed by the electronic device, a password to a website, etc.

In step 410, the OS, the app, or the website may request that the user present the contactless-enabled card that was used in provisioning the authentication credential to the electronic device.

In step 415, the user may present the contactless-enabled card to the electronic device. For example, the user may tap the contactless-enabled card on the electronic device.

In step 420, the electronic device may read data from the contactless-enabled card.

In step 425, the electronic device may present a challenge to the user for verification, such as entering a personal identification number (PIN). In one embodiment, the PIN may be a PIN for a financial instrument (e.g., a debit card PIN), a zip code (e.g., a U.S. zip code that is tied to the credit card billing address) or a device Personal Identification Number (PIN) in Android or passcode in Apple iOS.

In step 430, the user may respond to the challenge by entering the requested information.

In one embodiment, the challenge and the challenge response may be optional.

In step 435, the electronic device may communicate the authentication credential, the card data, and the challenge response, if provided) to a backend, such as the entity that issued the authentication credential.

In step 440, the backend may retrieve contactless card data for cards associated with the user associated with the authentication credential, and may verify that the card data received matches that for a contactless card issued to the user. Thus, the same contactless card that was used to provision the authentication credential need not be presented.

The backend may further validate the challenge response, if provided.

In step 445, if there is a match, in step 450, the backend may approve the change and may communicate the approval to the operating system, the app, or the website. If there is not a match, in step 455, the backend may reject the change and may communicate the rejection to the operating system, the app, or the website.

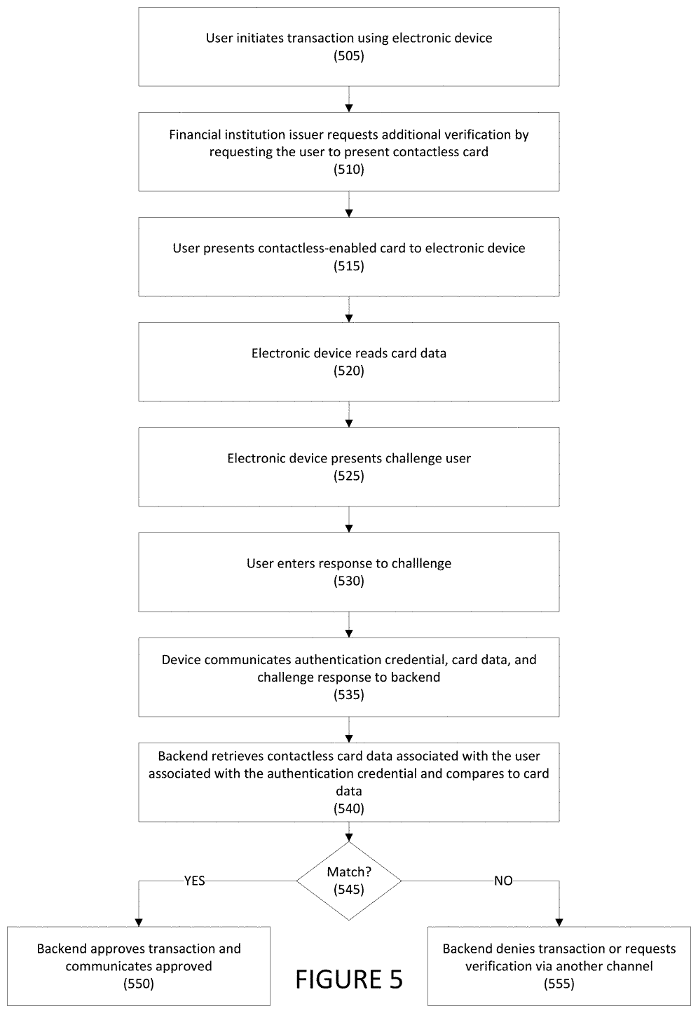

Referring to FIG. 5, a method for transaction authorization using a provisioned authentication credential is disclosed according to one embodiment.

In step 505, a user may initiate a transaction, such as a purchase, using a token that may be provisioned on an electronic device. In one embodiment, this may be a payment token.

In step 510, as part of the authorization process, the issuing financial institution may receive the transaction and may determine that additional verification is necessary. In one embodiment, this may be due to suspected fraud, and the financial institution may want to verify that the financial instrument that was used to provision the authentication credential is present.

In one embodiment, the additional verification may be requested randomly, periodically, the first time a payment token is used, when a transaction exceeds a certain amount, when a transaction is conducted outside the user's normal transaction area, when the transaction is conducted overseas or in an area with an increased risk for fraud, etc. Any suitable basis for requesting verification may be used as is necessary and/or desired.

In one embodiment, the issuing financial institution may communicate this request to the operating system, may request the verification by SMS message, in-app message, etc.

In step 515, the user may present the contactless-enabled card to the electronic device. For example, the user may tap the contactless-enabled card on the electronic device.

In step 520, the electronic device may read data from the contactless-enabled card.

In step 525, the electronic device may present a challenge to the user for verification, such as entering a personal identification number (PIN). In one embodiment, the PIN may be a PIN for a financial instrument (e.g., a debit card PIN), a zip code (e.g., a U.S. zip code that is tied to the credit card billing address) or a device Personal Identification Number (PIN) in Android or passcode in Apple iOS.

In step 530, the user may respond to the challenge by entering the requested information.

In one embodiment, the challenge and the challenge response may be optional.

In step 535, the electronic device may communicate the authentication credential, the card data, and the challenge response, if provided) to a backend, such as the entity that issued the authentication credential.

In step 540, the backend may retrieve contactless card data for cards associated with the user associated with the authentication credential, and may verify that the card data received matches that for a contactless card issued to the user. Thus, the same contactless card that was used to provision the authentication credential need not be presented.

The backend may further validate the challenge response, if provided.

In step 545, if there is a match, in step 550, the backend may approve the transaction and may communicate the approval to the financial institution or merchant. If there is not a match, in step 555, the backend may deny the transaction and communicate the rejection to the financial institution or merchant. In one embodiment, the user maybe be authenticated in a different manner, such as out-of-band authentication.

In one embodiment, the authentication credential may be used to provide identity as a service to a relying party, such as a credit bureau, to perform a credit check, to a third party digital payment wallet to perform maintenance and payment card provisioning, or to enable a digital experience with an approved third-party vendor.

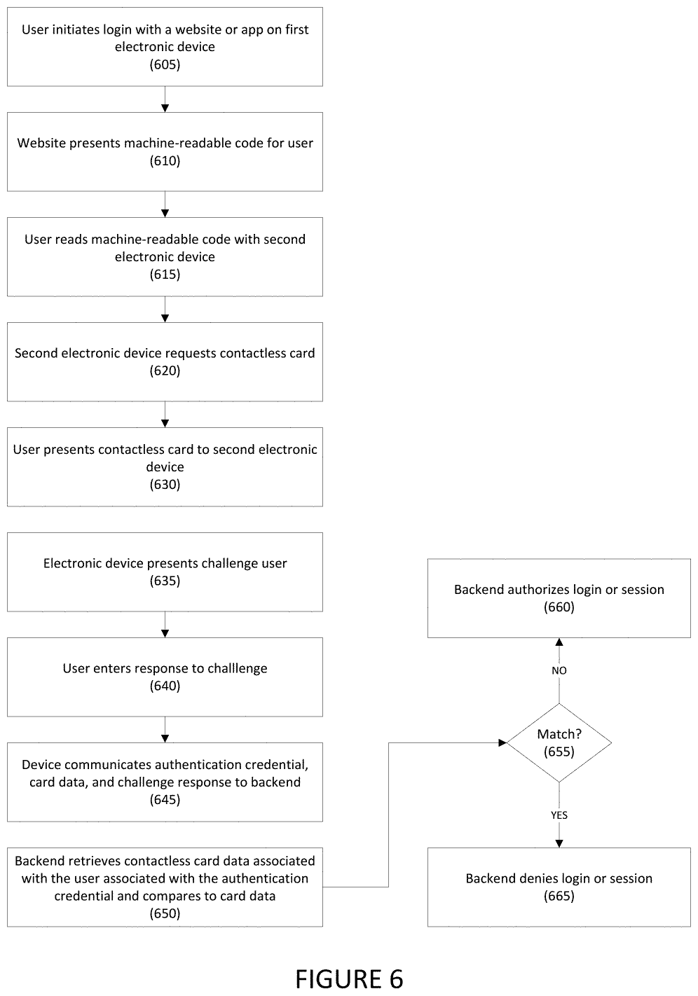

Referring to FIG. 6, a method for establishing an authenticated session using a provisioned authentication credential is disclosed according to one embodiment.

In step 605, a user may initiate a login with a website, an application, etc. on a first electronic device. In one embodiment, the user may access the website or application using a laptop computer, desktop computer, terminal, workstation, kiosk, etc.

In step 610, the website may cause the first electronic device to display machine-readable code (e.g., a QR code), to the user.

In step 615, the user may scan the machine-readable code with a second electronic device (e.g., a mobile electronic device such as a smartphone), which may cause the mobile electronic device to initiate a verification process.

In step 620, the second electronic device may be linked to a website that may request that the user present a contactless card to the second electronic device.

In step 625, the user may present the contactless-enabled card to the electronic device. For example, the user may tap the contactless-enabled card on the electronic device.

In step 630, the second electronic device may read data from the contactless-enabled card.

In step 635, the second electronic device may present a challenge to the user for verification, such as entering a personal identification number (PIN). In one embodiment, the PIN may be a PIN for a financial instrument (e.g., a debit card PIN), a zip code (e.g., a U.S. zip code that is tied to the credit card billing address) or a device Personal Identification Number (PIN) in Android or passcode in Apple iOS.

In step 640, the user may respond to the challenge by entering the requested information.

In one embodiment, the challenge and the challenge response may be optional.

In step 645, the second electronic device may communicate the authentication credential, the card data, and the challenge response, if provided) to a backend, such as the entity that issued the authentication credential.

In step 650, the backend may retrieve contactless card data for cards associated with the user associated with the authentication credential, and may verify that the card data received matches that for a contactless card issued to the user. Thus, the same contactless card that was used to provision the authentication credential need not be presented.

The backend may further validate the challenge response, if provided.

In step 655, if there is a match, in step 660, the backend may approve the access and may generate a control signal to instruct the website or application to allow access on the first electronic device. In one embodiment, a secure session may be established.

If there is not a match, in step 665, the backend may deny the access and communicate the denial to the website or app on the first electronic device.

Embodiments may provide some or all of the following advantages. First, identity corroboration using the contactless card as an authentic “device” (plastic) credential with something he/she has that is proven legitimate and untampered using EMVCo cryptogram, and a PIN or other confidential value to validate the user with something the user knows. Second, embodiments provide authenticator binding—when these three things (card, user and device) come together, the user identity, original device identity (plastic) and the new device identity (mobile device on which the credential is provisioned) are associated with each other. Thus, the credential may be re-presented at each login as an unaltered user/device identity (just as the card did at the time of provisioning).

In one embodiment, the contactless card may be used to unlock the financial institution authentication credential. For example, if the cardholder's financial institution biometric and n-digit PIN/quick-code are both locked, or if the cardholder gets a new mobile device, he or she may present the contactless card to the mobile device-financial institution authentication credential.

In one embodiment, the cardholder may be required to enter his or her banking PIN, an OTP, etc.

In another embodiment, the financial institution authentication credential may be recovered or reset using an ATM, another device, etc.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the iPadOS operating system, the macOS operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Go, Java, Modula-2, Pascal, Rhyton, Prolog, REXX, Rust, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for provisioning an authentication credential to an electronic device, comprising:
in a backend information processing apparatus comprising at least one computer processor:
receiving, from an electronic device associated with a user, card data for a contactless card, an authorization cryptogram, and a challenge response;
authenticating the user based on the authorization cryptogram, the card data, and the challenge response;
generating and sending a response cryptogram to the electronic device;
returning a cardholder account to the electronic device;
wherein the electronic device generates a public/private key pair for the electronic device, an online service, and the cardholder account; and
wherein the electronic device persists the public/private key pair in secure storage thereon.

2. The method of claim 1, wherein the contactless card is a NFC-enabled card.

3. The method of claim 1, wherein the challenge comprises a PIN.

4. The method of claim 1, wherein the electronic device communicates the public key to the online service, and the online service stores the public key.

5. The method of claim 1, wherein the authorization cryptogram comprises an authorization request cryptogram, and the response cryptogram comprises an authorization response cryptogram.

6. A method for provisioning an authentication credential to a mobile electronic device, comprising:
in a mobile electronic device associated with a user comprising at least one computer processor:
receiving card data for a contactless card;
generating an authorization cryptogram for the card data;
prompting the user for a challenge response;
receiving the challenge response from the user;
communicating the card data, the authorization cryptogram, and the challenge response to a financial institution backend;
receiving, from the financial institution backend, a response cryptogram;
generating a public/private key pair for the electronic device, an online service, and the cardholder account; and
persisting the public/private key pair in secure storage.

7. The method of claim 6, wherein the contactless card is a NFC-enabled card.

8. The method of claim 6, wherein the challenge comprises a PIN.

9. The method of claim 6, further comprising communicating the public key to the online service;
wherein the online service stores the public key.

10. A method for processing an access request received on a mobile electronic device, comprising:
in a mobile electronic device associated with a user comprising at least one computer processor:
receiving card data for a contactless card;
receiving an authentication credential from secure storage on the mobile electronic device;
communicating an access request comprising the card data and the authentication credential to a backend; and
receiving approval for the access request from the backend;
wherein the backend retrieves stored card data for a contactless card associated with the authentication credential and approves the access request when the card data matches the stored card data.

11. The method of claim 10, wherein the card comprises a NFC card.

12. The method of claim 10, further comprising:
prompting the user for a challenge response; and
receiving the challenge response from the user;
wherein the backend verifies the user based on the card data and the challenge response.

13. The method of claim 12, wherein the challenge response comprises a PIN.

14. The method of claim 10, wherein the access request comprises access to an application executed by the mobile electronic device.

15. The method of claim 10, wherein the access request comprises access to an application executed by a second mobile electronic device

16. The method of claim 10, wherein the access request comprises a request to change a password or passcode for an application or a website.

17. The method of claim 10, wherein the access request comprises a transaction request.

18. The method of claim 10, wherein the access request comprises a login request to a website.

19. The method of claim 10, wherein the request is to authenticate a user to a third party.

20. The method of claim 10, wherein the authentication credential comprises a public/private keypair.
